(19) United States
(12) Patent Application Publication
(10) Pub. No.: US 2024/0402721 A1
(43) Pub. Date: Dec. 5, 2024

(54) METHODS AND APPARATUS FOR PROVIDING ASSISTANCE TO AN AUTONOMY SYSTEM USING A TELEOPERATIONS SYSTEM

(71) Applicant: Nuro, Inc., Mountain View, CA (US)

(72) Inventors: Emily Anna WESLOSKY, Menlo Park, CA (US); Yichao (Roger) SHEN, Mountain View, CA (US); Benjamin Tian-You THOMSEN, San Francisco, CA (US); Barbara SCHLOSS BEYDA, Los Gatos, CA (US)

(73) Assignee: Nuro, Inc., Mountain View, CA (US)

(21) Appl. No.: 18/631,694

(22) Filed: Apr. 10, 2024

Related U.S. Application Data
(60) Provisional application No. 63/469,964, filed on May 31, 2023.

(51) Int. Cl. G05D 1/227; G05D 1/622; G05D 109/10

(52) U.S. Cl. CPC G05D 1/227; G05D 1/622; G05D 2109/10

(57) ABSTRACT

According to one aspect, a method includes obtaining a first supervisory request at a teleoperations indirect control arrangement that is originated by a first vehicle that has an autonomy system. The method also includes identifying a first situation associated with the first supervisory request. A first mitigation for the first situation is identified, and it is determined whether the first mitigation includes providing a point-of-intent to the autonomy system. When the first mitigation includes providing the point-of-intent to the autonomy system, the point-of-intent is provided. In response to providing the point-of-intent, a first plurality of potential paths between a current location of the first vehicle and the point-of-intent is obtained. A first potential path of the first plurality of potential paths is selected by the teleoperations indirect control arrangement, and a first indication that the first vehicle is to use the first potential path is provided to the first vehicle.

### PRIORITY CLAIM

This patent application claims the benefit of priority under 35 U.S.C. § 119 to U.S. Provisional Patent Application No. 63/469,964, filed May 31, 2023, and entitled “METHODS AND APPARATUS FOR PROVIDING ASSISTANCE TO AN AUTONOMY SYSTEM USING A TELEOPERATIONS SYSTEM,” which is incorporated herein by reference in its entirety.

### TECHNICAL FIELD

The disclosure relates to providing systems for use with autonomous vehicles. More particularly, the disclosure relates to systems which provide operational support for autonomous vehicles.

### BACKGROUND

Fleets of autonomous or semi-autonomous vehicles are often monitored by remote operators, e.g., operators of teleoperations systems or operators of remote controls. When an autonomous vehicle that is part of a fleet encounters an issue, an operator of a teleoperations system may take control of the vehicle. When the operator takes control of the vehicle, the operator uses the teleoperations system to remotely operate the vehicle. While a teleoperations system may enable a vehicle to effectively overcome an issue, the overhead associated with using a teleoperations system to remotely operate the vehicle may be substantial.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a diagrammatic representation of a framework in which a teleoperations arrangement, e.g., a teleoperations indirect control arrangement, communicates with a vehicle which has encountered an issue in accordance with an embodiment.

FIG. 5 is a diagrammatic representation of a framework, e.g., framework 450 of FIG. 4, in which a teleoperations arrangement determines that an autonomy system of a vehicle may identify at least one alternate path for the vehicle to traverse autonomously in order to mitigate an on-road situation in accordance with an embodiment.

FIG. 6A is a diagrammatic representation of a planned path for an autonomous vehicle that traverses an on-road situation, e.g., a construction zone, in accordance with an embodiment.

FIG. 6B is a diagrammatic representation of alternate paths for an autonomous vehicle, e.g., autonomous vehicle 601 of FIG. 6A, span between a current location of the autonomous vehicle and a point-of-intent in accordance with an embodiment.

FIGS. 7A and 7B are a process flow diagram which describes a method of operating an autonomous vehicle in a framework that includes at least one teleoperations indirect control arrangement which may be used to provide at least one waypoint for routing purposes in accordance with an embodiment.

FIG. 8 is a diagrammatic representation of a framework which includes a fleet of autonomous vehicles, a teleoperations indirect control arrangement, and one or more teleoperations system in accordance with an embodiment.

FIG. 9 is a block diagram representation of a teleoperations indirect control arrangement in accordance with an embodiment.

FIGS. 10A and 10B are a process flow diagram which describes a method of operating an autonomous vehicle in a framework that includes at least one teleoperations indirect control arrangement which may be used to identify a blockage in accordance with an embodiment.

FIG. 11A is a diagrammatic representation of a planned path for an autonomous vehicle that traverses an on-road situation that may be identified as suitable for defining a blockage in accordance with an embodiment.

FIG. 11B is a diagrammatic representation of blockage defined around an on-road situation in the path of a vehicle, e.g., on-road situation 1160 and autonomous vehicle 1101 of FIG. 11A, span between a current location of the autonomous vehicle and a destination in accordance with an embodiment.

FIG. 11C is a diagrammatic representation alternate paths around a of blockage in the path of a vehicle, e.g., blockage 1166 and autonomous vehicle 1101 of FIG. 11A, span between a current location of the autonomous vehicle and destination in accordance with an embodiment.

FIG. 12 is a diagrammatic representation of a display screen that is part of a teleoperations indirect control arrangement, e.g., teleoperations indirect control arrangement 952 of FIG. 9, in accordance with an embodiment.

FIGS. 13A and 13B are a process flow diagram which illustrates a method of operating a teleoperations indirect control arrangement in accordance with an embodiment.

### DESCRIPTION OF EXAMPLE EMBODIMENTS

### General Overview

According to one aspect, a method includes obtaining a first supervisory request at a teleoperations indirect control arrangement, the first supervisory request being originated by a first vehicle, the first vehicle having an autonomy system, the autonomy system configured to enable the first vehicle to operate autonomously. The method also includes identifying a first situation associated with the first supervisory request, wherein the first situation is identified by the first vehicle as affecting operation of the first vehicle. A first mitigation for the first situation is identified, and it is determined whether the first mitigation includes providing a point-of-intent to the autonomy system. When it is determined that the first mitigation includes providing the point-of-intent to the autonomy system, the point-of-intent is provided to the autonomy system and in response to providing the point-of-intent to the autonomy system, a first plurality of potential paths between a current location of the first vehicle and the point-of-intent is obtained. Using the teleoperations indirect control arrangement, a first potential path of the first plurality of potential paths is selected, and a first indication that the first vehicle is to use the first potential path is provided to the first vehicle.

In accordance with another embodiment, a non-transitory storage medium encoded with code devices that, when executed by at least one processor, cause the at least one processor to perform operations comprising obtaining a first supervisory request at a teleoperations indirect control arrangement, the first supervisory request being originated by a first vehicle, the first vehicle having an autonomy system, the autonomy system configured to enable the first vehicle to operate autonomously, and identifying a first situation associated with the first supervisory request, wherein the first situation is identified by the first vehicle as affecting operation of the first vehicle. The code devices are also operable to identify a first mitigation for the first situation, determine whether the first mitigation includes providing a point-of-intent to the autonomy system, and when it is determined that the first mitigation includes providing the point-of-intent to the autonomy system, providing the point-of-intent to the autonomy system and obtaining, in response to providing the point-of-intent to the autonomy system, a first plurality of potential paths between a current location of the first vehicle and the point-of-intent;. The code devices are operable to cause a first potential path of the first plurality of potential paths to be selected by the teleoperations indirect control arrangement, and to cause a first indication that the vehicle is to use the first potential path to be provided by the teleoperations indirect control arrangement.

According to still another embodiment, a platform includes a plurality of vehicles, a queue, and at least a first teleoperations indirect control arrangement. The plurality of vehicles includes a first vehicle, the first vehicle including an autonomy system configured to enable the first vehicle to operate autonomously. The queue is configured to contain a first supervisory request, the first supervisory request being originated by a first vehicle. The first teleoperations indirect control arrangement is arranged to communicate with the plurality of vehicles, and is configured to obtain the first supervisory request from the queue, and to identify a first situation associated with the first supervisory request, wherein the first situation is identified by the first vehicle as affecting operation of the first vehicle. The first teleoperations indirect control arrangement also identifies a first mitigation for the first situation, determines whether the first mitigation includes providing a point-of-intent to the autonomy system, and when it is determined that the first mitigation includes providing the point-of-intent to the autonomy system, provide the point-of-intent to the autonomy system and obtaining, in response to providing the point-of-intent to the autonomy system, a first plurality of potential paths between a current location of the first vehicle and the point-of-intent. Using the teleoperations indirect control arrangement, a first potential path of the first plurality of potential paths is selected, and a first indication that the first vehicle is to use the first potential path is provided to the first vehicle.

In one embodiment, when a vehicle that is operating autonomously encounters a situation that the vehicle is unable to address while safely operating autonomously, the vehicle may send a supervisory request to a teleoperations indirect controller arrangement which may provide input to the vehicle to effectively enable the vehicle to continue operating autonomously. When the situation is an on-road situation, the input may be a point-of-intent to which the vehicle may identify paths that enable the vehicle to avoid the on-road situation, or a blockage around which the vehicle may create paths. The vehicle may provide the identified paths to the teleoperations indirect arrangement, and the teleoperations indirect arrangement may confirm or otherwise select a substantially best path to the point-of intent or around the blockage. The vehicle may then be able to autonomously drive to the point-of-intent or drive around the blockage.

### DESCRIPTION

Teleoperations systems, or teleoperations direct controllers, are often used to support the operation of autonomous and semi-autonomous vehicles. For example, an autonomous vehicle may be monitored using a teleoperations system such that if the vehicle encounters an issue while operating autonomously, a remote operator may use the teleoperations system to control the vehicle. Typically, a single teleoperations system may be used to monitor and to take control of a single vehicle at any given time.

While having a dedicated teleoperations system that enables an operator to drive a remote vehicle for each vehicle of a fleet of autonomous vehicles allows each vehicle to operate safely in the event that autonomous mode is not possible, the use of dedicated teleoperations systems may be an inefficient use of resources. When a vehicle is capable of operating in an autonomous mode for a majority of the time that the vehicle is in use, the allocation of a dedicated teleoperations system and a dedicated teleoperator to effectively be “on call” to operate the vehicle through teleoperations when necessary may be inefficient. In addition, for relatively large fleets of autonomous vehicles, obtaining and maintaining the number of dedicated teleoperations systems needed to facilitate the safe deployment of the autonomous vehicles may be impractical. Further, in some instances, a teleoperator may substantially unnecessarily take control of a vehicle when the teleoperator determines that the vehicle is unable to operate autonomously when, in fact, the vehicle may actual be capable of operating autonomously in a safe manner.

By enabling a vehicle to obtain guidance from a source external to the vehicle when an issue such as an unusual scene or circumstance is encountered, while the vehicle is operating autonomously, the vehicle may be able to use the guidance to identify a new path to traverse, as for example guidance from a source external to the vehicle, that enables the vehicle to generate one or more alternate paths to traverse. The external source may be a teleoperations indirect control arrangement which may provide guidance to the vehicle upon request, and also coordinate the remote operation of the vehicle and/or an extraction of the vehicle as appropriate. Enabling a vehicle to continue to operate autonomously with input provided by a teleoperations indirect control arrangement enables teleoperations resources to be allocated efficiently. Allowing an autonomy system of the vehicle to be leveraged whenever possible also improves the overall use of resources within a framework. Further, enabling multiple vehicles which are operating in an autonomous mode to be substantially services using a single teleoperations indirect control arrangement also facilitates the efficient allocation of resources.

A teleoperations indirect control arrangement may include a display screen which may be used to monitor an environment around a vehicle when the vehicle issues a supervisory request upon encountering an on-road situation such as a road blockage. The teleoperations indirect control arrangement may provide the ability, as for example through an operator of the teleoperations indirect control arrangement, to provide a vehicle with guidance that the vehicle may use to identify one or more alternate paths which will enable the vehicle to autonomously operate substantially around the on-road situation. The teleoperations indirect control arrangement may also arrange for an extraction of the vehicle, or control of the vehicle using a teleoperations system, if the on-road situation is one that the vehicle may not be able to navigate around in an autonomous manner.

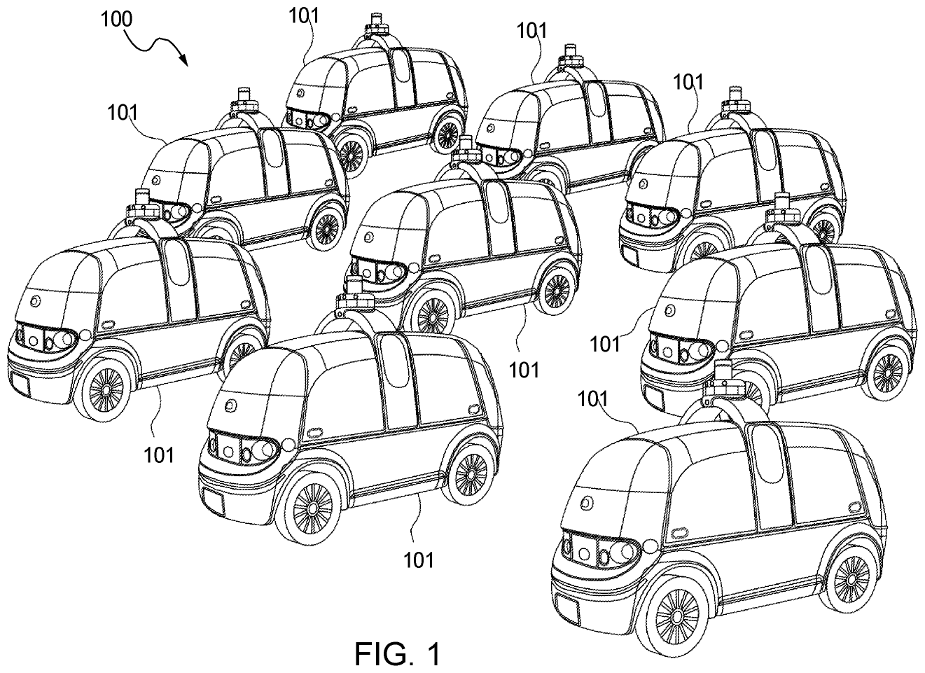

A platform which includes at least one teleoperations indirect control arrangement may include a fleet of vehicles capable of operating in fully autonomous and/or semi-autonomous modes. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

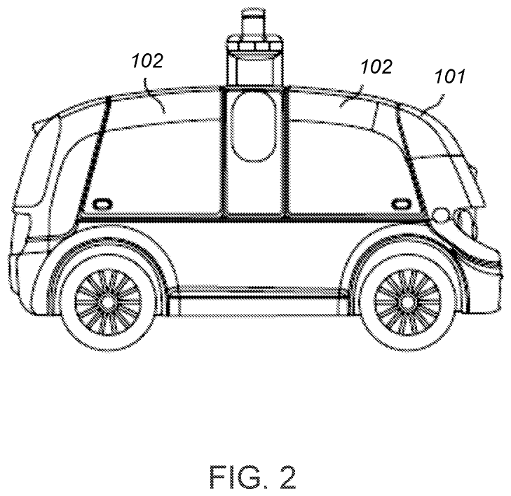

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

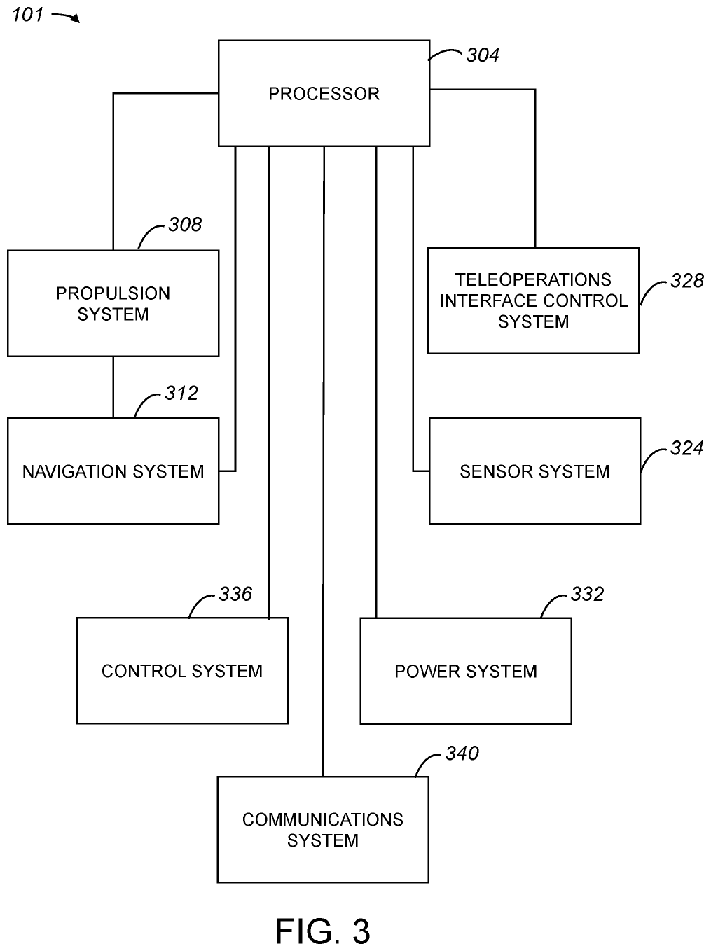

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324 a teleoperations interface control system 328, a power system 332, a control system 336, and a communications system 340. It should be appreciated that processor 304, propulsion system 308, navigation system 312, sensor system 324, teleoperations interface control system 328, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

In one embodiment, sensor system 324 is configured to enable autonomous vehicle 101 to identify a potential issue, e.g., an on-road situation such as a road blockage. Enabling autonomous vehicle 101 to identify a potential issue may effectively substantially necessitate providing autonomous vehicle 101 with information that may enable autonomous vehicle 101 to effectively autonomously navigate around the potential issue.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Teleoperations interface control system 328 generally enables vehicle 101 to be controlled remotely, as for example by a teleoperations direct control or operator arrangement. That is, teleoperations interface control system 328 enables vehicle 101 to operate by obtaining and processing instructions provided by a teleoperations operator arrangement. Additionally, teleoperations interface control system 328 may enable vehicle 101 to determine when vehicle 101, while operating autonomously, may benefit from being controlled via teleoperations and to request remote monitoring and/or control by a teleoperator. In one embodiment, teleoperations interface control system 328 enables vehicle 101 to communicate with a teleoperations indirect control arrangement, and/or a teleoperations operator arrangement. A teleoperations indirect control arrangement will be discussed below in accordance with an embodiment.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

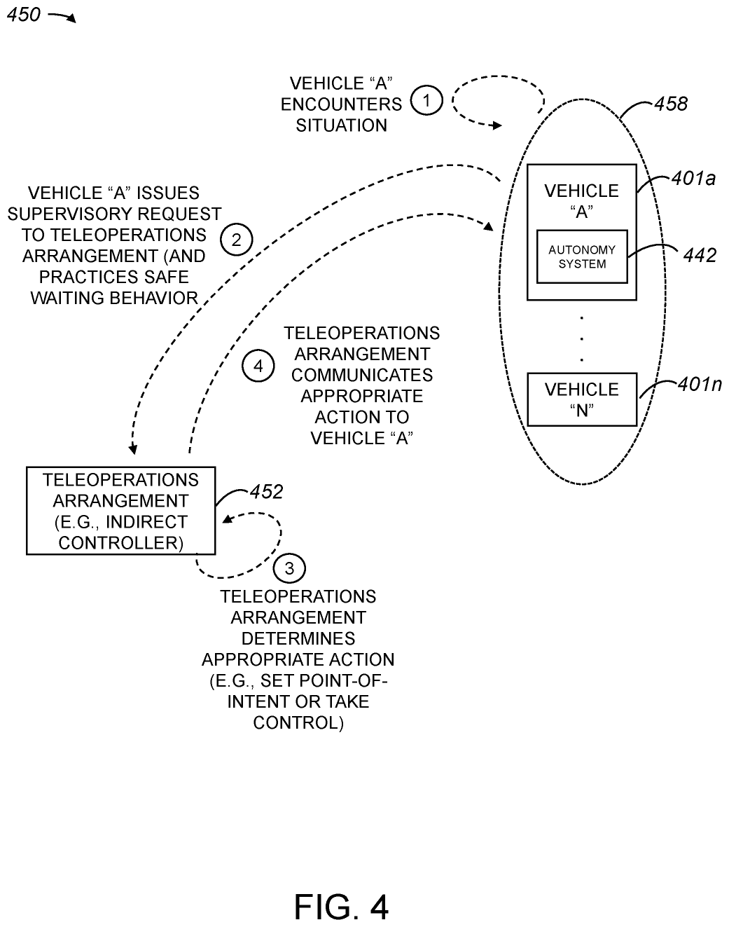

With reference to FIG. 4, a framework in which a teleoperations arrangement, e.g., a teleoperations indirect control arrangement, communicates with a vehicle which has encountered an issue will be discussed in accordance with an embodiment. A framework 450 includes a fleet 458 of vehicles 401a-n and a teleoperations arrangement 452. Teleoperations arrangement 452 may be a teleoperations indirect controller. It should be appreciated that in some instances, teleoperations arrangement 452 may be a teleoperations direct control or operator arrangement which is capable of remotely operating vehicles 401a-n that also include the functionality of a teleoperations indirect controller.

As shown, vehicle “A” 401a includes autonomy system 442 that includes sensors, hardware, and/or software logic which enables vehicle “A” 401a to operate autonomously. In general, autonomy system 442 includes perception and planning functionality which enables vehicle “A” 401a to understand the environment in which vehicle “A” 401a is operating and also enables vehicle “A” 401a to identify one or more paths to traverse.

At a time T1, vehicle “A” 401a is operating autonomously, and encounters a situation. The situation may generally be any situation for which vehicle “A” 401a is uncertain of an ability to safely continue operating autonomously. That is, the situation may be an issue that causes vehicle “A” 401a to determine that vehicle “A” 401a may not be able to autonomously operate on a planned path between a source point and a destination point. The situation may involve systems on vehicle “A” 401a not operating as expected and/or potential issues in the environment around vehicle “A” 401a. Systems not operating as expected may include, but are not limited to including, a compute system and/or sensor systems. In general, the situation may be an issue that vehicle “A” 401a may essentially need assistance to understand and/or assistance to continue to safely operate.

Upon encountering the situation, vehicle “A” 401a issues a supervisory request to teleoperations arrangement 452 at a time T2. That is, vehicle “A” 401a originates or otherwise creates a supervisory request. The supervisory request may be provided to teleoperations arrangement 452 over a network, e.g., a wireless network such as a 3G/4G/5G or LTE network. In one embodiment, the supervisory request may provide an indication of what type of situation vehicle “A” 401a has encountered. The situation may generally be perceived by vehicle “A” 401a as impeding the ability for vehicle “A” 401a to safely traverse a path between a source point and a destination point. It should be appreciated, however, that the supervisory request may instead substantially only specify that vehicle “A” 401a is requesting an evaluation of systems on vehicle “A” 401a and/or the environment around vehicle “A” 401a. In one embodiment, when vehicle “A” 401a issues a supervisory request, vehicle “A” 401a also implements a safe waiting behavior, e.g., vehicle “A” 401a may come to a stop at a current location or vehicle “A” 401a may pull over to a stop in a safe location . . . .

At a time T3, after obtaining the supervisory request from vehicle “A” 401a, teleoperations arrangement 452 determines an appropriate action to take, or a mitigation arranged to enable the situation associated with the supervisory request to be addressed. For example, if teleoperations arrangement ascertains that the situation is one that may not be autonomously navigated by vehicle “A” 401a, teleoperations arrangement 452 may arrange for an extraction team to extract or to otherwise retrieve vehicle “A′ 401a, or teleoperations arrangement 452 may arrange for vehicle “A” 401a to be remotely operated. In one embodiment, teleoperations arrangement 452 may substantially match vehicle “A” 401a to an appropriate teleoperations system to remotely operate vehicle “A” 401a. When teleoperations arrangement 452 determines that an appropriate action is for vehicle “A” 401a to identify a new path to traverse that would enable vehicle “A” 401a to substantially autonomously drive around the situation, then teleoperations arrangement 452 may identify a point-of-intent that may be used by autonomy system 442 to generate at least one alternate path for vehicle “A” 401a. The point-of-intent may generally be a location that autonomy system 442 may use as a destination or end-point when generating a path that allows the situation to be avoided.

In one embodiment, an operator using teleoperations arrangement 452 may provide input into teleoperations arrangement 452 relating to the appropriate action to take. For example, an operator may use one or more display screens of teleoperations arrangement 452 to assess the situation, and determine an appropriate action to take based on the assessment. The assessment may then be provided by the operator to the teleoperations arrangement 452, e.g., using a user interface.

At a time T4, teleoperations arrangement 452 communicates the appropriate action to vehicle “A” 401a. The communication may generally be a response to the supervisory request issued by vehicle “A” 401a.

When a situation is an on-road situation and an appropriate action for vehicle “A” 401a involves vehicle “A” 401a identifying alternate paths that avoid the on-road situation, teleoperations arrangement 452 may be involved in the selection of an alternate path to use. The on-road situation may include, but is not limited to including, a road blockage, a construction zone, and/or a detour.

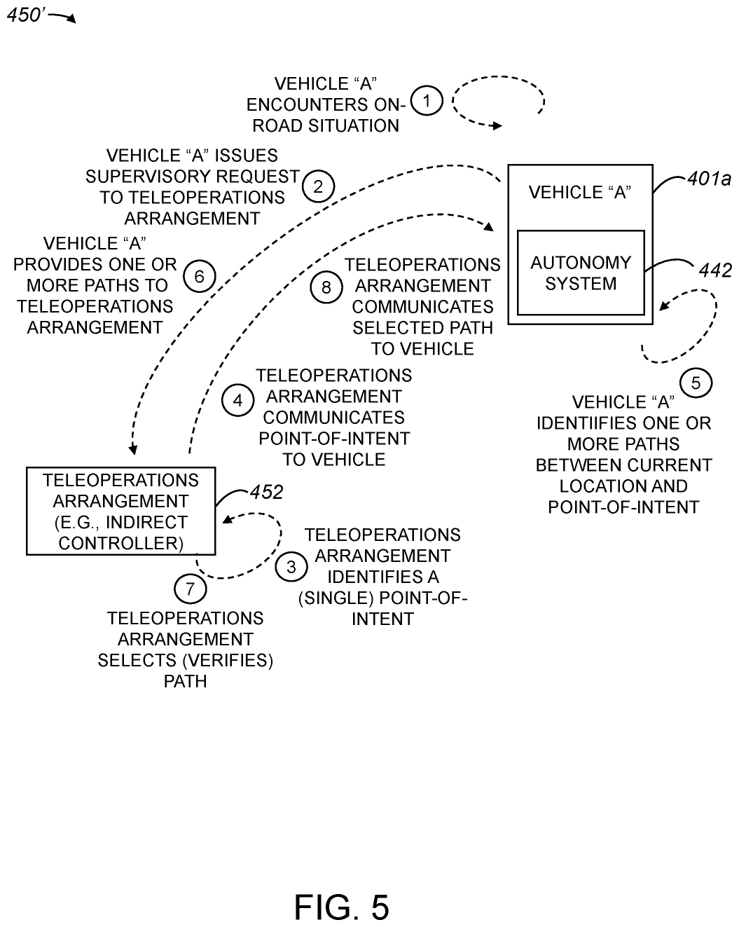

FIG. 5 is a diagrammatic representation of framework 450 in which a teleoperations arrangement determines that an autonomy system of a vehicle may identify at least one alternate path for the vehicle to traverse autonomously in order to mitigate an on-road situation in accordance with an embodiment. Within framework 450′, vehicle “A” 401a operates autonomously. At a time T1, vehicle “A” 401a encounters an on-road situation.

At a time T2, vehicle “A” 401a issues a supervisory request to teleoperations arrangement 452. In one embodiment, the supervisory request may include context which essentially identifies the on-road situation.

At a time T3, after obtaining the supervisory request, teleoperations arrangement 452 identifies a point-of-intent. The point-of-intent is a location that teleoperations arrangement 452 determines to be a desirable location for autonomy system 442 to use as a destination point for routing at least one alternate path. That is, the point-of-intent is a target location identified by teleoperations arrangement 452 that autonomy system 442 may use as a destination for path determination purposes. The point-of-intent may generally be any physical location which does not overlap with a location associated with the on-road situation.

After the teleoperations arrangement identifies a point-of-intent, the teleoperations arrangement communicates the point-of-intent to autonomy system 442 or, more generally, vehicle “A” 401a, at a time T4. Upon obtaining the point-of intent, vehicle “A” 401a identifies one or more paths between the current location of the vehicle and the point-of-intent at a time T5. That is, autonomy system 442 identifies at least one suitable path or route that vehicle “A” 401a may traverse to substantially avoid the on-road situation.

At a time T6, vehicle “A” 401a provides one or more paths between the current location of the vehicle and the point-of-intent to teleoperations arrangement 452. In one embodiment, vehicle “A” 401a may identify a preferred path, and may provide an indication of the preferred path to vehicle “A” 401a for verification. In other words, vehicle “A” 401a may select a preferred path and essentially ask teleoperations arrangement 452 to confirm that the preferred path is to be used.

At a time T7, teleoperations arrangement 452 selects, e.g., verifies, a path from the paths provided by vehicle “A” 401a. Once a path is selected, teleoperations arrangement 452 communicates with vehicle “A” 401a inform vehicle “A” 401a of the selected path. In one embodiment, vehicle “A” 401a may confirm that a preferred path is to be selected.

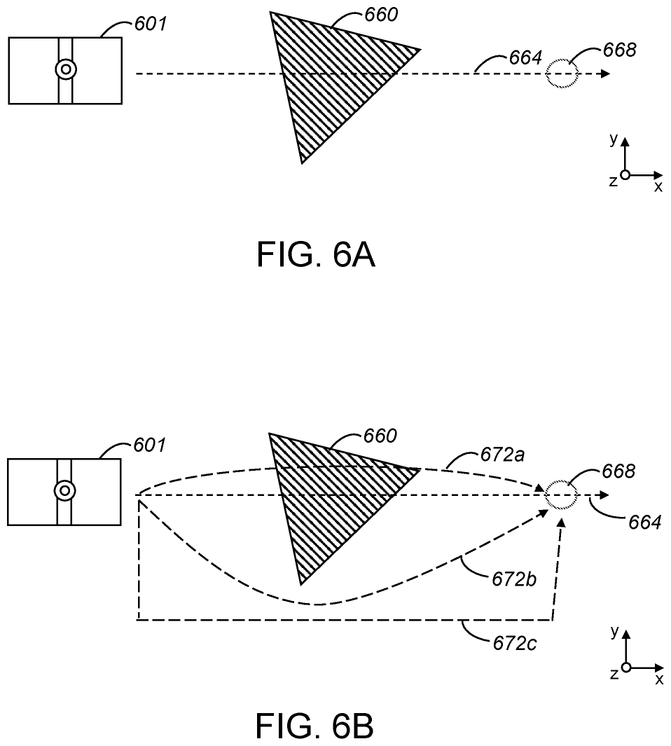

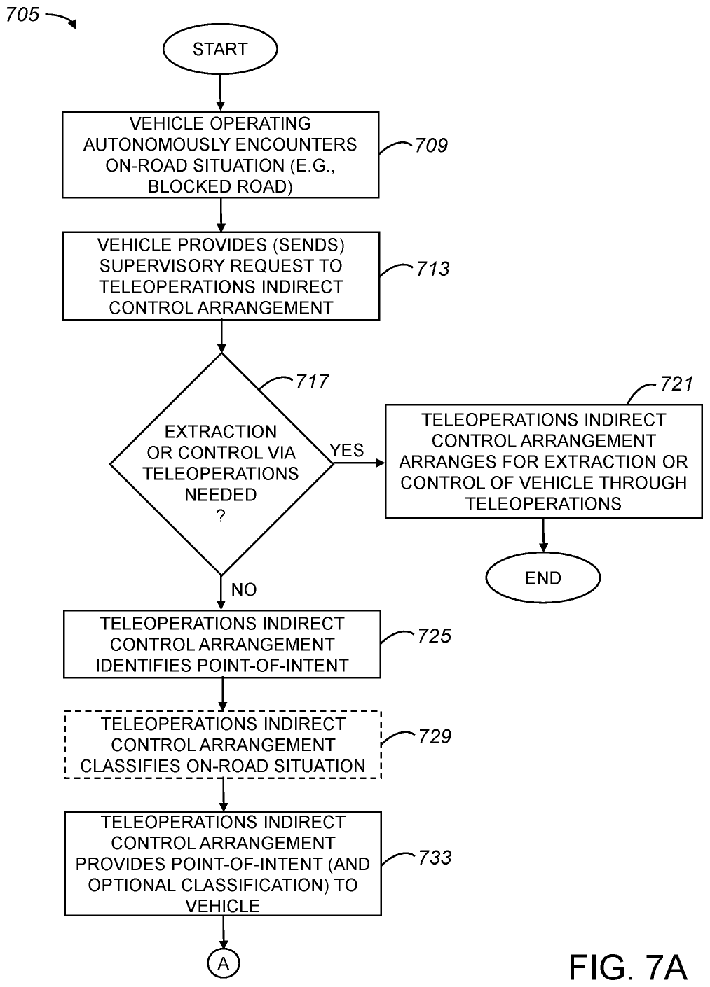

FIG. 6A is a diagrammatic representation of a planned path for an autonomous vehicle that traverses an on-road situation, e.g., a construction zone, in accordance with an embodiment. A vehicle 601 may be driving or otherwise operating, e.g., operating autonomously, along a planned path 664. Along planned path 664, an on-road situation 660 is present which may impact the ability of vehicle to continue along planned path 664. On-road situation 660 may be a construction zone, but is not limited to being a construction zone. For example, on-road situation 660 may be a vehicle accident, debris or an object on a road, a situation associated with a school zone, and/or any other obstruction along planned path 664.

When planned path 664 is not navigable, e.g., when vehicle 601 may not continue driving along the planned path due to the presence of on-road situation 660, a point-of-intent 668 may be identified. Point-of-intent 668 may be located substantially anywhere that is not within an area covered by on-road situation 660. In other words, point-of-intent 668 is not located within an area associated with on-road situation 660. As shown, point-of-intent 668 is along planned path 664, although it should be appreciated that point-of-intent 668 is not limited to being located along planned path 664. Point-of-intent 668 may be identified by a teleoperations arrangement such as a teleoperations indirect controller or control arrangement. In one embodiment, an operator may provide point-of-intent 668 to vehicle 601 via a teleoperations arrangement.

Once vehicle 601 obtains information relating to point-of-intent 668, vehicle 601 may identify potential paths between a current location of vehicle 601 and point-of-intent 668. As shown in FIG. 6B, one or more alternate paths 672a-c between a location of vehicle 601 and point-of-intent 668 are identified in accordance with an embodiment. An autonomy system of vehicle 601 may use information relating to point-of-intent 668 to identify any number of paths between a current location of vehicle 601 and point-of-intent 668. It should be appreciated that although one point-of-intent 668 is shown, more than one point-of-intent may be provided to facilitate identifying potential paths 672a-c which substantially avoid on-road situation 660. For example, an additional point-of-intent (not shown) may be provided at a distance away from on-road situation relative to a y-axis.

While three potential paths 672a-c are shown, it should be understood that the number of potential paths 672a-c that are identified may vary widely depending upon factors including, but not limited to including, how many paths are feasible, parameters set by an enterprise that substantially specify a desired number of paths, and/or how many paths exist that meet particular requirements.

A selected path may be identified from among potential paths 672a-c. The considerations associated with selecting a path may generally include, but are not limited to including, path lengths, speeds at which paths may be traversed, traffic flows typically associated each path, and/or path requirements set by an enterprise.

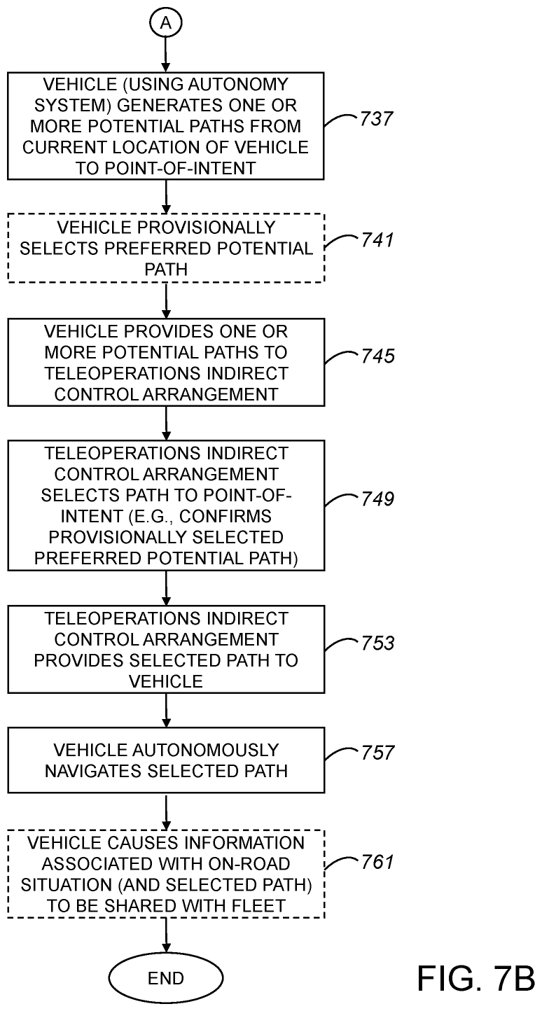

FIGS. 7A and 7B are a process flow diagram which describes a method of operating an autonomous vehicle in a framework that includes at least one teleoperations indirect control arrangement in accordance with an embodiment. A method 705 of operating an autonomous vehicle begins at a step 709 in which a vehicle that is operating autonomously encounters an on-road situation such as a road blockage or a blocked road.

In a step 713, the vehicle provides, e.g., sends, a supervisory request to a teleoperations indirect control arrangement to essentially request guidance for mitigating the on-road situation, e.g., a road blockage. Upon obtaining or receiving the supervisory request, the teleoperations indirect control arrangement assesses the supervisory request, and a determination is made in a step 717 as to whether an extraction of the vehicle or control of the vehicle via teleoperations is effectively needed. That is, it is determined whether a suitable mitigation for the on-road situation is an extraction of the vehicle or control of the vehicle via teleoperations.

If it is determined in step 717 that the vehicle is to be extracted or controlled using a teleoperations operator arrangement, the indication is that identifying a point-of-intent is either not possible or not useful. Accordingly, process flow proceeds to a step 721 in which the teleoperations indirect control arrangement arranges for extraction of the vehicle or control of the vehicle using a teleoperations operator arrangement. Once the extraction or control through teleoperations is arranged, the method of operating an autonomous vehicle is completed.

Alternatively, if it is determined in step 717 that no extraction or control via teleoperations is needed, the implication is that the vehicle may be able to continue operating autonomously while avoiding the on-road situation. As such, in a step 725, the teleoperations indirect control arrangement identifies a point-of intent. Then, in an optional step 729, the teleoperations indirect control arrangement may classify the on-road situation. The teleoperations indirect control arrangement may take input form an operator that identifies the on-road situation, and may store and/or share a classification. Sharing a classification may involve providing the classification to the vehicle that issued the supervisory request to enable the vehicle to recognize future similar on-road situations as having the classification.

In a step 733, the teleoperations indirect control arrangement provides a point-of intent to the vehicle and an optional classification to the vehicle. After the vehicle obtains or receives the point-of-intent and, optionally, a classification associated with the on-road situation, the vehicle generates one or more alternate or potential paths from the current location of the vehicle to the point-of intent in a step 737. An autonomy system of the vehicle may identify the one or more potential paths.

In an optional step 741, the vehicle may provisionally select a preferred potential path between the current location of the vehicle and the point-of intent. That is, the vehicle may determine a substantially best path to travel from the current location to the point-of-intent given the on-road situation. The best path may be determined using any suitable criterion including, but not limited to including, the length of a path, the speed at which a path may be traversed, and/or preferences of an enterprise associated with the vehicle.

The vehicle provides the one or more potential paths to the teleoperations indirect control arrangement in a step 745. If the vehicle has provisionally selected a preferred potential path, the provisional selection is also provided to the teleoperations indirect control arrangement.

Once the teleoperations indirect control arrangement obtains the one or more potential paths and, optionally, a preferred potential path, the teleoperations indirect control arrangement selects a path to the point-of-intent in a step 749. The path may be selected by an operator, and an indication of the selected path may be provided by the operator to the teleoperations indirect control arrangement. In one embodiment, selecting a path may include substantially confirming the provisionally selected preferred potential path that was effectively pre-selected by the vehicle.

After the teleoperations indirect control arrangement selects a path, the teleoperations indirect control arrangement provides the selected path to the vehicle in a step 753. That is, the teleoperations indirect control arrangement communicates a selected path to the vehicle. Once the vehicle obtains the path selection from the teleoperations indirect control arrangement, the vehicle autonomously navigates the selected path in a step 757.

In an optional step 761, the vehicle may cause information associated with the on-road situation and the selected path to be provided to other vehicles, e.g., other vehicles in the same fleet as the vehicle or other vehicles associated with the same enterprise as the vehicle. In one embodiment, the vehicle may cause such information to be provided by a teleoperations indirect control arrangement. The method of operating an autonomous vehicle is completed after the vehicle autonomously navigates the selected path, and optionally provides information associated with the on-road situation and the selected path to a fleet that includes the vehicle, e.g., to a mission control system associated with the fleet.

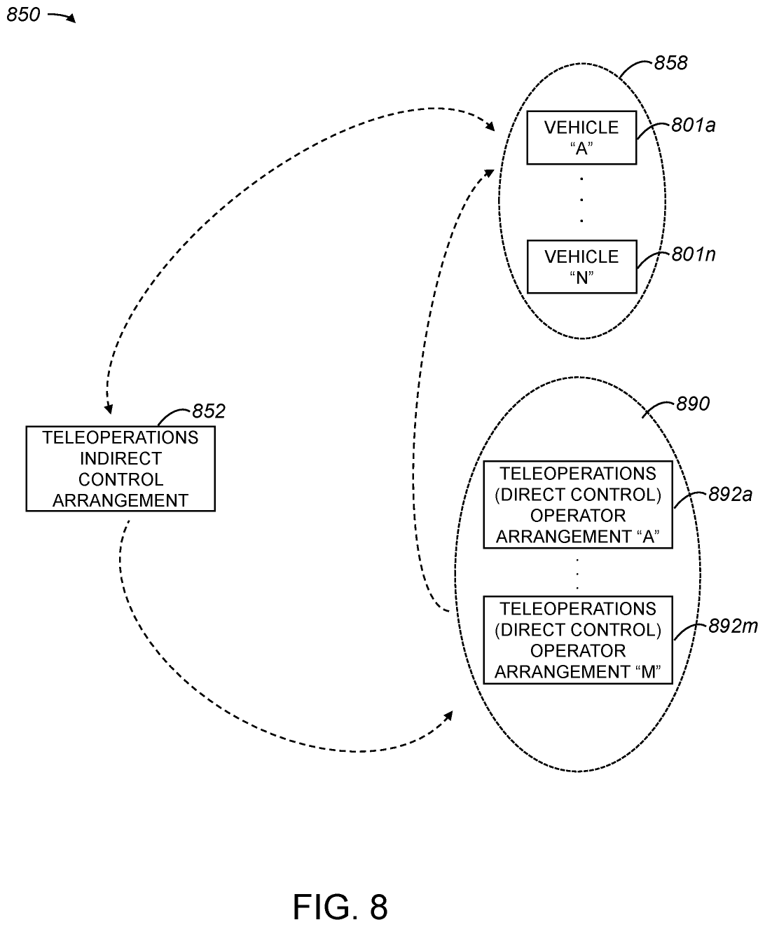

A platform or a framework that includes a teleoperations indirect control arrangement may include multiple vehicles and multiple teleoperations operator arrangements, or teleoperations systems. FIG. 8 is a diagrammatic representation of a framework which includes a fleet of autonomous vehicles, a teleoperations indirect control arrangement, and one or more teleoperations system in accordance with an embodiment. A framework 850 includes a fleet 858 of vehicles 801a-n, and a set 890 of teleoperations operator arrangements or teleoperations direct control arrangements 892a-m. One or more vehicles 801a-n is capable of operating autonomously, and of issuing a supervisory request to a teleoperations indirect control arrangement 852 when a situation is encountered for which guidance is desired. It should be appreciated that although one teleoperations indirect control arrangement 852 is shown, framework 850 may include a plurality of teleoperations indirect control arrangements which may receive supervisory requests from fleet 858 and communicate with set 890 of teleoperations operator arrangements 892a-m.

Teleoperations indirect control arrangement 852 is configured to obtain a supervisory request from a vehicle 801a-n, assess a situation identified in the supervisory request, and take an appropriate action. The appropriate action may involve setting a point-of-intent for use by an autonomy system of vehicle 801a-n that issued the supervisory request. In some situations, teleoperations indirect control arrangement 852 may assign a teleoperations operator arrangement 892a-m to remotely operate vehicle 801a-n in response to the supervisory request. Teleoperations operator arrangements 892a-m may generally be teleoperations direct control arrangements. Assigning a teleoperations operator arrangement 892a-m may generally include, but is not limited to including, selecting an appropriate teleoperations operator arrangement 892a-m, and causing control of a vehicle 801a-n to be passed to the appropriate teleoperations operator arrangement 892a-m. It should be appreciated that teleoperations indirect control arrangement 852 may also dispatch an extraction vehicle in response to a supervisory request.

While framework 850 includes a single teleoperations indirect control arrangement 852, it should be appreciated that framework 850 may instead include more than one teleoperations indirect control arrangement 852. Single teleoperations indirect control arrangement 852 may obtain or receive supervisory requests from more than one vehicle 801a-n. When the supervisory requests are obtained at approximately the same time, teleoperations indirect control arrangement 852 may prioritize the supervisory requests such that the supervisory requests are effectively queued based on priorities. The order of priority may be based on any suitable criterion including, but not limited to including, when a supervisory request is received, a criticality associated with the supervisory request, a location of a vehicle making or issuing the supervisory request, and/or a type of vehicle making or issuing the supervisory request.

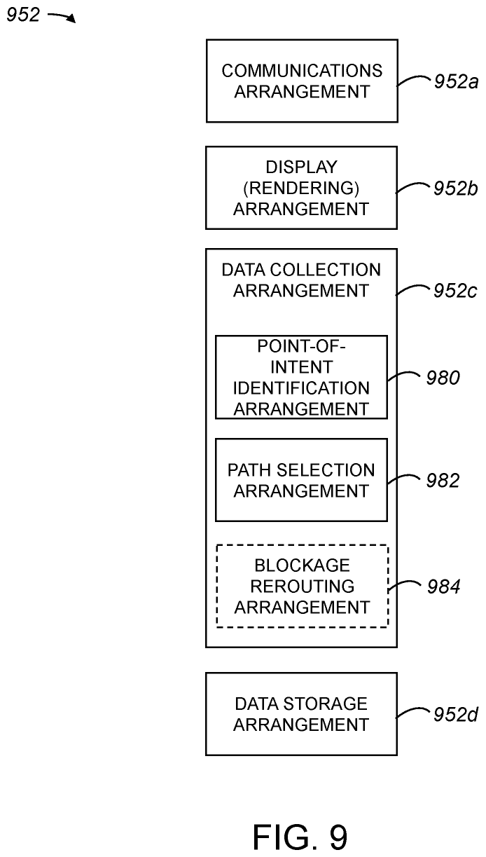

FIG. 9 is a block diagram representation of a teleoperations indirect control arrangement in accordance with an embodiment. A teleoperations indirect control arrangement 952 may be embodied as hardware and/or software logic encoded on a computer-readable medium, and may be a standalone apparatus or may be part of an overall teleoperations system that has the functionality to remotely control a vehicle.

Teleoperations indirect control arrangement 952 includes a communications arrangement 952a, a display or rendering arrangement 952b, a data collection arrangement 952c, and a data storage arrangement 952d. Communications arrangement 952a generally enables teleoperations indirect control arrangement 952 to provide information to, and obtain information from, a vehicle. That is, communications arrangement 952a allows teleoperations indirect control arrangement 952 to send and to receive data across a network. Communications arrangement 952a also includes an interface which allows communications arrangement 952a to receive input, e.g., input from an operator. Display arrangement 952b allows information to be rendered such that an operator may view the information. For example, display arrangement 952b may include one or more screens on which information obtained from a vehicle may be displayed. Data collection arrangement 952c is configured to enable data to be collected. In one embodiment, data collection arrangement 952c may obtain information that an enterprise has requested and store the information in data storage arrangement 952d. Data collection arrangement 952c includes a point-of-intent identification arrangement 980 that may store a point-of-intent that is determined and a path selection arrangement 982 that may store a path selected from potential paths provided by an autonomy system of a vehicle.

Data collection arrangement 952c may include an optional blockage rerouting or identification arrangement 984. Blockage rerouting arrangement 984 is configured to effectively define an area in an environment to effectively block such that routes that may be generated for a vehicle may not pass through the area that is blocked, e.g., a blockage. Blockage rerouting arrangement 984 may be arranged to determine an outline or a boundary of an obstruction, and define a polygon around the outline. Once the polygon is defined, the area within the polygon is effectively identified as an area through which a route for an autonomous vehicle may not pass, e.g., a blockage.

A blockage may be identified when there is no feasible route through an area. By way of example, a traffic light outage may be an obstruction that results in a blockage being defined. Blockages may also be defined or otherwise identified for obstructions including, but not limited to including, construction zones, road closures, and/or events such as parades and concerts. (***Can you please elaborate on what other obstructions/issues might result in a blockage being defined or otherwise identified? ***) In some situations, a blockage identified by a teleoperations indirect control arrangement may be propagated such that the blockage is provided to other teleoperations indirect control arrangements and autonomy systems of multiple vehicles in the same enterprise as the teleoperations indirect control arrangement. That is, information relating to a blockage may be provided on a network and provided to a fleet of vehicles.

A blockage may also be identified when an obstructions appears to be relatively long term, or unlikely to be resolved quickly. For example, an area around a traffic light outage may be defined as a blockage for a predetermined amount of time. That is, when an obstruction is deemed to be unlikely to be resolved in the near term, a teleoperations indirect control arrangement may associate a blockage with the obstruction, and effectively identify the blockage on a map for a predetermined amount of time.

In general, when a teleoperations indirect control arrangement determines that, in response to a supervisory request, a vehicle may identify a path that the vehicle may navigate autonomously, the teleoperations indirect control arrangement may either identify at least one waypoint or may define a blockage. The autonomy system of the vehicle may then identify one or more alternative paths for the vehicle to traverse that uses the waypoint when the waypoint is provided, or avoids the blockage when the blockage is provided. In one embodiment, a blockage may be defined, and one or more points-of-intent or waypoints may be identified to facilitate routing around the blockage. For example, for a traffic light outage at an intersection, a blockage may be defined to effectively block the intersection for all vehicles in a fleet, while a vehicle that originated a supervisory request that resulted in the blockage being defined may be provided with at least one waypoint to enable that vehicle to be routed around or past the blockage. It should be appreciated that in some situations, a blockage may be defined for a particular lane associated with a first traffic direction, and at least one waypoint may provide a way to navigate past the blockage by driving in a lane associated with a second traffic direction. (***Would it be possible to define a blockage and, at the same time, provide one or more waypoints? Is this something that you would contemplate? ***)

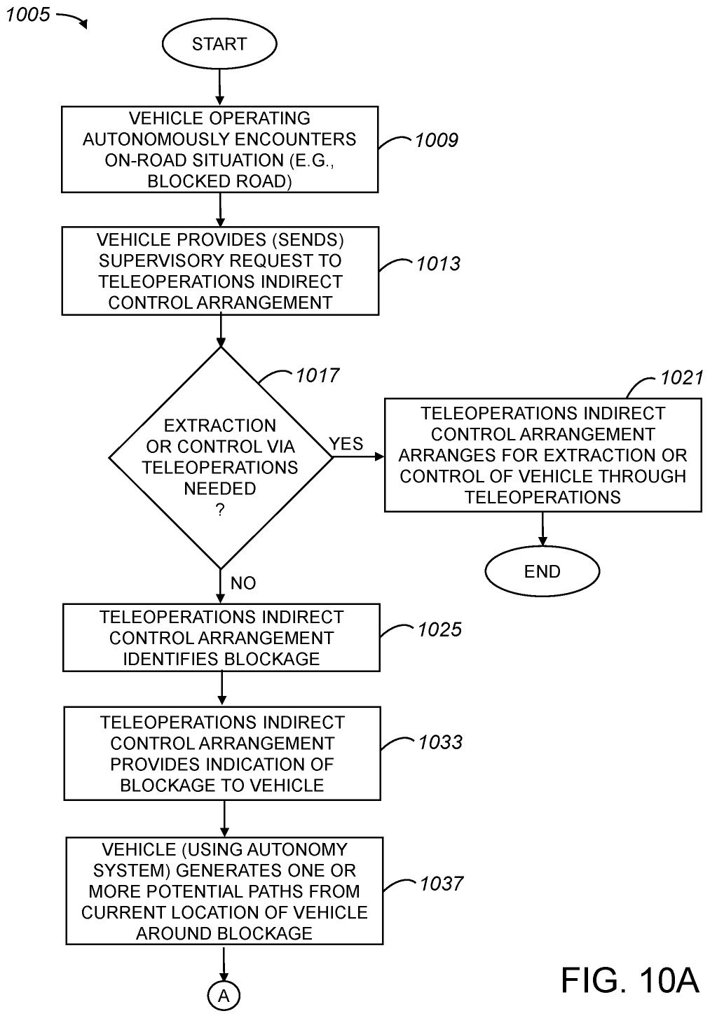

FIGS. 10A and 10B are a process flow diagram which describes a method of operating an autonomous vehicle in a framework that includes at least one teleoperations indirect control arrangement which may be used to identify a blockage in accordance with an embodiment. A method 1005 of operating an autonomous vehicle begins at a step 1009 in which a vehicle that is operating autonomously encounters an on-road situation such as a blocked or impassable road.

In a step 1013, the vehicle provides a supervisory request to a teleoperations indirect control arrangement to essentially request guidance for mitigating the on-road situation. After obtaining the supervisory request, the teleoperations indirect control arrangement assesses the supervisory request, and determines in a step 1017 whether an extraction of the vehicle or control of the vehicle via teleoperations is effectively needed.

If it is determined in step 1017 that the vehicle is to be extracted or controlled using a teleoperations operator arrangement, the indication is that the vehicle is unlikely to be able to operate autonomously even if a blockage is defined by the teleoperations indirect control arrangement around the on-road situation. Accordingly, process flow proceeds to a step 1021 in which the teleoperations indirect control arrangement arranges for extraction of the vehicle or control of the vehicle using a teleoperations operator arrangement. Once the extraction or control through teleoperations is arranged, the method of operating an autonomous vehicle is completed.

Alternatively, if the determination in step 1017 is that no extraction or control via teleoperations is needed, the implication is that the vehicle may be able to continue operating autonomously while effectively avoiding the on-road situation. In the described embodiment, the implication is that the vehicle may be able to continue operating autonomously if provided with information relating to a blockage, e.g., a polygon defined around the on-road situation to effectively fence off the area within the polygon from being accessible when a path is determined. Accordingly, in a step 1025, the teleoperations indirect control arrangement identifies a blockage. Identifying a blockage may include, but is not limited to including, determining a boundary substantially around the on-road situation and identifying the area defined by the boundary as inaccessible for path routing purposes.

In a step 1033, the teleoperations indirect control arrangement provides information relating to the blockage to the vehicle. It should be appreciated that the information relating to the blockage may include a classification associated with the on-road situation.

After the vehicle obtains or receives the information relating to the blockage, the vehicle generates one or more alternate or potential paths from the current location of the vehicle to a destination that substantially avoids the blockage in a step 1037. That is, the vehicle generates one or more potential paths from the current location of the vehicle to a destination that effectively route around the blockage. An autonomy system of the vehicle may identify the one or more potential paths.

From step 1037, process flow proceeds to an optional step 1041 in which the vehicle may provisionally select a preferred potential path between the current location of the vehicle and a destination that avoids the blockage. That is, the vehicle may determine a substantially best path to travel from the current location that effectively routes around the blockage. The best path may be determined using any suitable criterion including, but not limited to including, the length of a path, the speed at which a path may be traversed, and/or preferences of an enterprise associated with the vehicle.

The vehicle provides the one or more potential paths to the teleoperations indirect control arrangement in a step 1045. If the vehicle has provisionally selected a preferred potential path, the provisional selection is also provided to the teleoperations indirect control arrangement.

Once the teleoperations indirect control arrangement obtains the one or more potential paths and, optionally, a preferred potential path, the teleoperations indirect control arrangement selects a path that avoids the blockage in a step 1049. The path may be selected by an operator, and an indication of the selected path may be provided by the operator to the teleoperations indirect control arrangement. In one embodiment, selecting a path may include substantially confirming the provisionally selected preferred potential path that was effectively pre-selected by the vehicle.

After the teleoperations indirect control arrangement selects a path, the teleoperations indirect control arrangement provides the selected path to the vehicle in a step 1053. Once the vehicle obtains the path selection from the teleoperations indirect control arrangement, the vehicle autonomously navigates the selected path in a step 1057.

The vehicle may cause information associated with the on-road situation and the selected path to be provided to other vehicles, e.g., other vehicles in the same fleet as the vehicle or other vehicles associated with the same enterprise as the vehicle in a step 1061. In one embodiment, the vehicle may cause such information to be provided to other vehicles by a teleoperations indirect control arrangement. The method of operating an autonomous vehicle is completed after the vehicle autonomously navigates the selected path, and optionally provides information associated with the on-road situation and the selected path to a fleet that includes the vehicle, e.g., to a mission control system associated with the fleet.

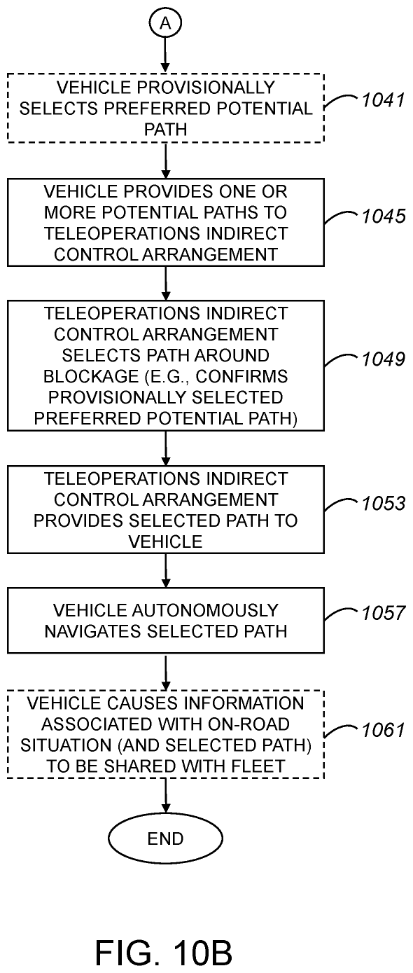

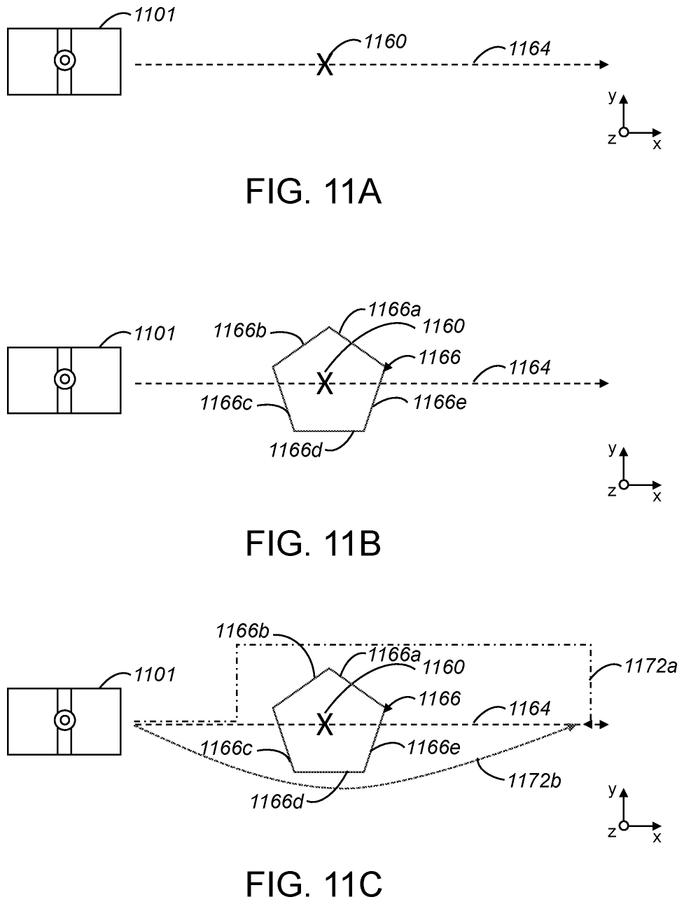

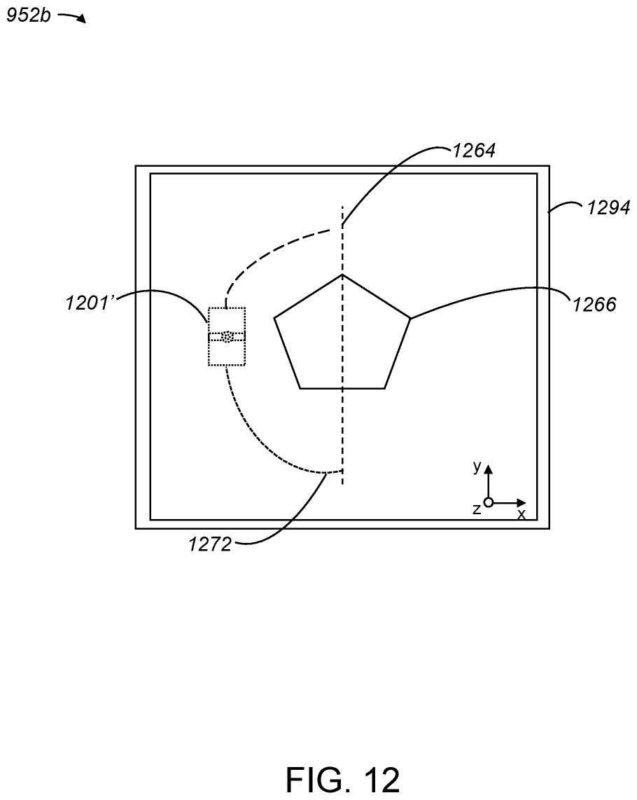

With reference to FIGS. 11A-C, the creation of alternate paths around an in-road situation around which a blockage is defined will be described in accordance with an embodiment. FIG. 11A is a diagrammatic representation of a planned path for an autonomous vehicle that traverses an on-road situation that may be identified as suitable for defining a blockage in accordance with an embodiment. A vehicle 1101 may operate autonomously along a planned path or route 1164 between an origin point and a destination point. As vehicle 1101 navigates, vehicle 1101 encounters an on-road situation or obstruction 1160 that blocks or otherwise prevents vehicle 1101 from operating autonomously along planned path 1164.

Once on-road situation 1160 is detected or otherwise identified, a teleoperations indirect control arrangement such as teleoperations indirect control arrangement 952 of FIG. 9 may determine that a blockage should is to be defined with respect to on-road situation 1160. In other words, it may be determined that on-road situation 1160 is to be substantially mitigated by defining a blockage, as for example instead of by identifying at least one point or intent or waypoint. Referring next to FIG. 11B, a blockage defined around on-road situation 1160 will be described in accordance with an embodiment. A blockage 1166 is defined substantially around on-road situation 1160 such that blockage 1166 effectively identified as an area through which a path may not be defined. As shown, blockage 1116 includes borders or boundaries 1166a-e that are defined around on-road situation 1160 such that an area defined within borders 1166a-e is considered to be unreachable for purposes of routing a new path.

Blockage 1166 may have substantially any shape, as for example relative to an xy-plane. In one embodiment, blockage 1166 borders or edges 1166a-e define a polygonal shape substantially around on-road situation 1160. That is, edges 1166a-e effectively define an area that encompasses on-road situation 1160.

Once blockage 1116 is defined, alternative paths that vehicle 1101 may drive autonomously may be defined. As shown in FIG. 11C, once blockage 1166 is defined, alternative paths 1172a, 1172b to a destination point that essentially avoid blockage 1166 may be identified, as for example using an algorithm. It should be appreciated that although two alternative paths 1172a, 1172b are shown, the number of alternative paths may generally vary.

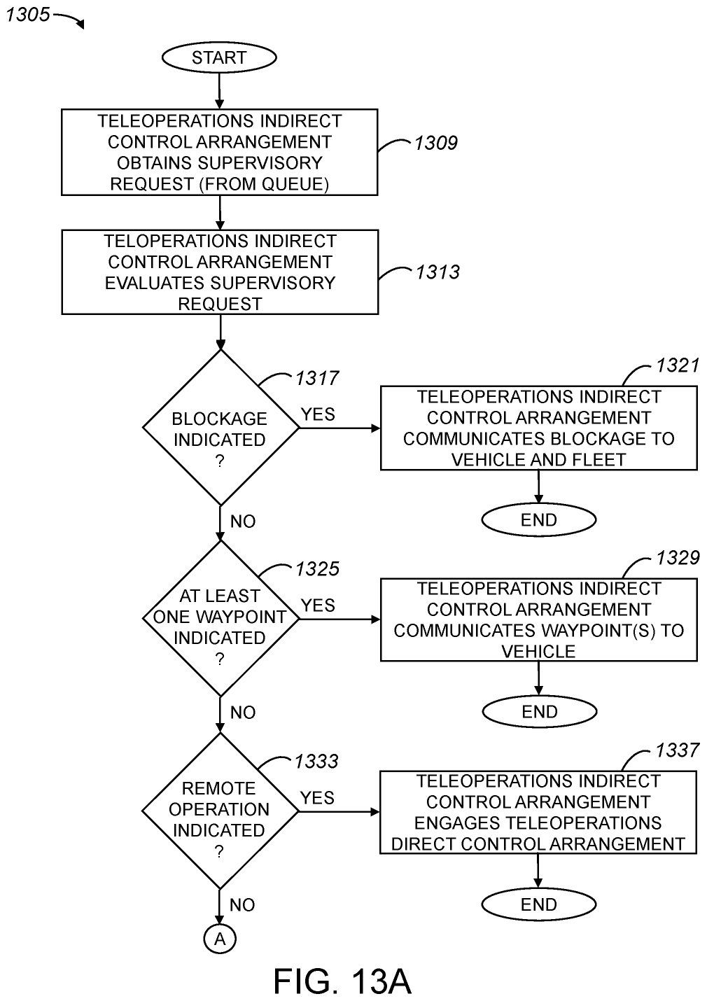

A teleoperations indirect control arrangement such as teleoperations indirect control arrangement 952 of FIG. 9 includes a display arrangement which may generally include a display screen or monitor. FIG. 12 is a diagrammatic representation of a display screen for a teleoperations indirect control arrangement, e.g., teleoperations indirect control arrangement 952 of FIG. 9, in accordance with an embodiment. Display or rendering arrangement 952b which may be included in teleoperations indirect control arrangement 952 of FIG. 9 may include a display screen 1294 which is configured to display a representation of an environment around a vehicle that is being monitored and/or driven by teleoperations indirect control arrangement 952. It should be appreciated that display screen 1294 may also display live video of the environment or scene around the vehicle.

As shown, a blockage 1266 is represented in display 1294, along with an intended or planned path 1264. Planned path 1264 is obstructed by blockage 1266 and, as such, an alternate path 1272 may be indicated in display 1294. In one embodiment, a representation of vehicle 1201′ is shown to provide an operator of teleoperations indirect control arrangement with an indication of where vehicle 1201′ would drive if following an alternate path 1272 that avoids blockage 1266. It should be appreciated that the renderings of blockage 1266, planned path 1264, alternate path 1272, and vehicle 1201′ may be shown from any suitable point of view. By way of example, the point of view may be a top-down point of view, or the point of view may be a view from behind vehicle 1201′ as vehicle travels relative to an xy-plane.

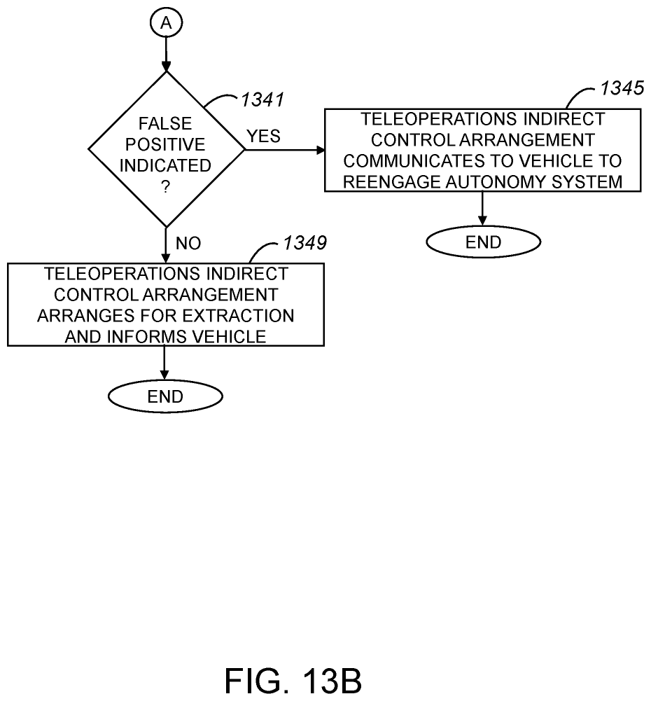

A teleoperations indirect control arrangement may generally determine whether to provide a point-of-intent or waypoint to an autonomy system of a vehicle, to define a blockage, to assign a teleoperations direct control arrangement to remotely operate the vehicle, and/or to provide an extraction for the vehicle. FIGS. 13A and 13B are a process flow diagram which illustrates a method of operating a teleoperations indirect control arrangement in accordance with an embodiment. A method 1305 of operating a teleoperations indirect control arrangement begins at a step 1309 in which the teleoperations indirect control arrangement obtains a supervisory request, e.g., from a queue of supervisory requests.

In a step 1313, the teleoperations indirect control arrangement evaluates the supervisory request. Evaluating the supervisory request may include, but is not limited to including, identifying an issue associated with the vehicle that originated the supervisory request and determining a suitable mitigation to address the issue. The issue may be an obstruction on a road or other issue which essentially prevents the vehicle from autonomously operating on a planned path to a destination.

A determination is made in a step 1317 whether, upon evaluating the supervisory request, a blockage is indicated. That is, the teleoperations indirect control arrangement determines whether to define a blockage that encompasses an obstruction in a planned path for the vehicle that originated the supervisory request. If the determination is that a blockage is indicated, the process flow proceeds to a step 1321 in which the teleoperations indirect control arrangement communicates the blockage and the overall fleet of vehicles of which the vehicle is a part. Communicating the blockage to the fleet provides the vehicles in the fleet with an awareness of the blockage and, thus, provides the vehicles with the ability to route around the blockage when determining a path from a source to a destination. Once the teleoperations indirect control arrangement communicates the blockage, the method of operating a teleoperations indirect control arrangement is completed.

Alternatively, if it is determined in a step 1317 that a blockage is not indicated, a determination is made in a step 1325 as to whether at least one point-of-intent or waypoint is indicated. If the determination is that one or more waypoints is indicated, the teleoperations indirect control arrangement communicates the one or more waypoints to the vehicle, and the method of operating a teleoperations indirect control arrangement is completed.

If it is determined in step 1325 that at least one waypoint is not indicated, the implication is that an autonomy system of the vehicle may not be able to effectively identify an alternate path that mitigates the issue associated with the supervisory request. In other words, when it is determined that the at least one waypoint is not indicated, the implication is that intervention may be needed. As such, in a step 1333, it is determined whether remote operation is indicated, e.g., whether a teleoperations direct control arrangement is to take control of the vehicle.

When it is determined in step 1333 that remote operation is indicated, then process flow proceeds to a step 1337 in which the teleoperations indirect control arrangement engages a teleoperations direct control arrangement. In other words, the teleoperations indirect control arrangement may substantially assign a teleoperations direct control arrangement to take control of the vehicle. The teleoperations indirect control arrangement may also communicate with the vehicle to inform the vehicle that the teleoperations direct control arrangement will remotely drive the vehicle. Once the teleoperations direct control arrangement is engaged, the method of operating a teleoperations indirect control arrangement is completed.

Alternatively, if it is determined in step 1333 that remote operation is not indicated, then process flow moves to a step 1341 in which the teleoperations indirect control arrangement determines whether a false positive is indicated. That is, it is determined whether the issue that triggered the vehicle to issue a supervisory request was a false positive and is not likely to be an issue which affects the ability of the vehicle to operate autonomously to traverse a planned path. If the determination is that a false positive is indicated, the teleoperations indirect control arrangement communicates to the vehicle that the vehicle is to reengage an autonomy system, and to resume autonomously driving along a planned path. The method of operating a teleoperations indirect control arrangement is completed upon the teleoperations indirect control arrangement communicating with the vehicle.

On the other hand, if it is determined in step 1341 that a false positive is not indicated, the implication is that the vehicle is unlikely to continue to operate. As such, in a step 1349, the teleoperations indirect control arrangement arranges for an extraction of the vehicle, and informs the vehicle that the vehicle is to be extracted. In one embodiment, the vehicle is extracted when the issue that the teleoperations indirect control arrangement identifies in the supervisory request may not be mitigated in any other manner. The method of operating a teleoperations indirect control arrangement is completed once the teleoperations indirect control arrangement arranges for the extraction.

Although only a few embodiments have been described in this disclosure, it should be understood that the disclosure may be embodied in many other specific forms without departing from the spirit or the scope of the present disclosure. By way of example, a teleoperations indirect controller may be used by an operator to provide input in response to a supervisory request from a vehicle, and the teleoperations indirect controller may then provide an instruction to the vehicle based on the input. In lieu of an operator providing input to a teleoperations indirect controller, a teleoperations indirect controller may instead include hardware and/or software logic that may assess a situation in response to a supervisory request, and provide an instruction after assessing the situation.

In some situations, a teleoperations indirect controller or control arrangement may assess an on-road situation and determine that a vehicle may continue to operate autonomously along a planned path. For instance, if the vehicle encounters an on-road situation that appears to be an object, the teleoperations indirect controller may determine that the object is not an obstacle that is to be avoided. By way of example, the object may be a pile of leaves that the vehicle may safely drive over. The teleoperations indirect controller may identify the pile of leaves, and communicate to the vehicle that the vehicle may safely drive over the pile of leaves. In such a case, the teleoperations indirect controller may effectively cause a “false positive” to be identified, and may confirm that the vehicle may continue driving an original or current path.

In one embodiment, in addition to providing a point-of-intent or a waypoint, a teleoperations indirect control arrangement may be used to propose a pose for a vehicle. By way of example, an operator of a teleoperations indirect control arrangement may identify a pose for a vehicle in addition to identifying a point-of-intent, and may provide that information to the teleoperations indirect control arrangement. The pose may be provided as a position of the vehicle, e.g., a position of the vehicle relative to a curb. Providing a pose may facilitate the ability of an autonomy system to better understand and, hence, process a point-of-intent. In one embodiment, a teleoperations indirect controller may also specify a velocity that the vehicle is to operate at.

Re-routing of a vehicle may be initiated in response to a path being selected to a point-of-intent. That is, a vehicle may identify a path to a point-of-intent, and may additionally, or alternatively, then also avoid a particular area associated with an original or current path. For instance, a teleoperations indirect control arrangement may cause an area associated with an original path to be blocked in response to an on-road situation, and an autonomy system of a vehicle may then re-route the vehicle to avoid the blocked area.

As discussed above, a teleoperations indirect control arrangement may identify or otherwise suggest a point-of-intent that may be used by an autonomy system of a vehicle to create one or more paths to be navigated by the vehicle. In one embodiment, a teleoperations indirect control arrangement may identify or suggest more than one point-of-intent that may be used by an autonomy system of a vehicle to generate at least one path that may be traversed by the vehicle, e.g., to avoid or to otherwise bypass an on-road situation.

A point-of-intent may be identified using any suitable method. For example, a point-of-intent may be identified by a teleoperator using a teleoperations indirect control arrangement, and provided by the teleoperations indirect control arrangement to a vehicle. Alternatively, a point-of-intent may be identified using an algorithm such as an artificial intelligence algorithm and provided to a teleoperations indirect control arrangement which may then provide the point-of-intent to a vehicle.

While a teleoperations indirect control arrangement has been described as being available to process supervisory requests from a fleet of vehicles, it should be appreciated that a teleoperations indirect control arrangement is not limited to processing supervisory requests from a plurality of vehicles. In addition, teleoperations direct control arrangements are not limited to being available to remotely operate vehicles selected from a fleet of vehicles. For example, a single vehicle may have a substantially dedicated teleoperations indirect control arrangement to evaluate supervisory requests from the single vehicle, as well as a substantially dedicated teleoperations direct control arrangement to take control of the single vehicle as appropriate.

While a vehicle may provide a plurality of potential paths to a teleoperations indirect control arrangement such that the teleoperations indirect control arrangement may select a suitable path for the vehicle, it should be understood that the vehicle may instead provide a single path or option such that the teleoperations indirect control arrangement may confirm that the single path is suitable. As previously mentioned, the vehicle may also provide a plurality of potential paths and identify a provisionally selected path that the teleoperations indirect control arrangement may confirm. The vehicle may also provide a prioritized list of potential paths such that the teleoperations indirect control arrangement may effectively understand the preference of the vehicle.

In general, a teleoperations indirect control arrangement is not arranged to take control of a vehicle, and may communicate with a vehicle to provide a point-of-intent and/or information relating to a blockage such that an autonomy system of the vehicle may generate a path to the point-of-intent or a path around the blockage. As described above, a teleoperations indirect control arrangement may communicate with a teleoperations direct control arrangement that is configured to remotely operate a vehicle. A teleoperations indirect control arrangement may, in some embodiments, include functionality which enables the teleoperations indirect control arrangement to cause the vehicle to come to a stop.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
obtaining a first supervisory request at a teleoperations indirect control arrangement, the first supervisory request being originated by a first vehicle, the first vehicle having an autonomy system, the autonomy system configured to enable the first vehicle to operate autonomously;
identifying a first situation associated with the first supervisory request, wherein the first situation is identified by the first vehicle as affecting operation of the first vehicle;
identifying a first mitigation for the first situation;
determining whether the first mitigation includes providing a point-of-intent to the autonomy system;
when it is determined that the first mitigation includes providing the point-of-intent to the autonomy system, providing the point-of-intent to the autonomy system and obtaining, in response to providing the point-of-intent to the autonomy system, a first plurality of potential paths between a current location of the first vehicle and the point-of-intent;
selecting, using the teleoperations indirect control arrangement, a first potential path of the first plurality of potential paths; and
providing, using the teleoperations indirect control arrangement, a first indication that the first vehicle is to use the first potential path.

2. The method of claim 1 wherein when it is determined that the first mitigation does not include providing the point-of-intent to the autonomy system, the method further includes:
determining whether the first mitigation includes providing a blockage indication that identifies a blockage to the autonomy system; and
when it is determined that the first mitigation includes providing the blockage indication that identifies the blockage to the autonomy system, providing the blockage indication that identifies the blockage to the autonomy system and obtaining, in response to providing the blockage indication that identifies the blockage to the autonomy system, a second plurality of potential paths that avoids the blockage.

3. The method of claim 2 further including:
selecting, using the teleoperations indirect control arrangement, a second potential path of the second plurality of potential paths; and
providing, using the teleoperations indirect control arrangement, a second indication that the first vehicle is to use the second potential path.

4. The method of claim 1 wherein when it is determined that the first mitigation does not include providing the point-of-intent to the autonomy system, the method further includes:
determining whether the first mitigation includes identifying a teleoperations direct control arrangement to remotely control the first vehicle; and
when it is determined that the first mitigation includes identifying the teleoperations direct control arrangement to remotely control the first vehicle, communicating to the first vehicle and the teleoperations direct control arrangement that the teleoperations direct control arrangement is to take control of the first vehicle.

5. The method of claim 5 wherein when it is determined that the first mitigation does not include identifying the teleoperations direct control arrangement to remotely control the vehicle, the method further includes:
communicating to the first vehicle that the first vehicle is to be extracted.

6. The method of claim 1 wherein obtaining the first supervisory request at the teleoperations indirect control arrangement includes selecting the first supervisory request from a plurality of supervisory requests.

7. The method of claim 1 wherein the first situation is an obstacle in a first planned path for the first vehicle from a source point to a destination point and providing the point-of-intent includes identifying the point-of-intent, wherein the point-of-intent is identified between the obstacle and the destination point.

8. A non-transitory storage medium encoded with code devices that, when executed by at least one processor, cause the at least one processor to perform operations comprising:
obtaining a first supervisory request at a teleoperations indirect control arrangement, the first supervisory request being originated by a first vehicle, the first vehicle having an autonomy system, the autonomy system configured to enable the first vehicle to operate autonomously;
identifying a first situation associated with the first supervisory request, wherein the first situation is identified by the first vehicle as affecting operation of the first vehicle;
identifying a first mitigation for the first situation;
determining whether the first mitigation includes providing a point-of-intent to the autonomy system;
when it is determined that the first mitigation includes providing the point-of-intent to the autonomy system, providing the point-of-intent to the autonomy system and obtaining, in response to providing the point-of-intent to the autonomy system, a first plurality of potential paths between a current location of the first vehicle and the point-of-intent;
selecting, using the teleoperations indirect control arrangement, a first potential path of the first plurality of potential paths; and
providing, using the teleoperations indirect control arrangement, a first indication that the first vehicle is to use the first potential path.

9. The non-transitory storage medium encoded with code devices of claim 8 wherein when it is determined that the first mitigation does not include providing the point-of-intent to the autonomy system, the method further includes:
determining whether the first mitigation includes providing a blockage indication that identifies a blockage to the autonomy system; and
when it is determined that the first mitigation includes providing the blockage indication that identifies the blockage to the autonomy system, providing the blockage indication that identifies the blockage to the autonomy system and obtaining, in response to providing the blockage indication that identifies the blockage to the autonomy system, a second plurality of potential paths that avoids the blockage.

10. The non-transitory storage medium encoded with code devices of claim 9 further including:
selecting, using the teleoperations indirect control arrangement, a second potential path of the second plurality of potential paths; and
providing, using the teleoperations indirect control arrangement, a second indication that the first vehicle is to use the second potential path.

11. The non-transitory storage medium encoded with code devices of claim 8 wherein when it is determined that the first mitigation does not include providing the point-of-intent to the autonomy system, the method further includes:
determining whether the first mitigation includes identifying a teleoperations direct control arrangement to remotely control the first vehicle; and
when it is determined that the first mitigation includes identifying the teleoperations direct control arrangement to remotely control the first vehicle, communicating to the first vehicle and the teleoperations direct control arrangement that the teleoperations direct control arrangement is to take control of the first vehicle.

12. The non-transitory storage medium encoded with code devices of claim 11 wherein when it is determined that the first mitigation does not include identifying the teleoperations direct control arrangement to remotely control the vehicle, the method further includes:
communicating to the first vehicle that the first vehicle is to be extracted.

13. The non-transitory storage medium encoded with code devices of claim 8 wherein obtaining the first supervisory request at the teleoperations indirect control arrangement includes selecting the first supervisory request from a plurality of supervisory requests.

14. The non-transitory storage medium encoded with code devices of claim 8 wherein the first situation is an obstacle in a first planned path for the first vehicle from a source point to a destination point and providing the point-of-intent includes identifying the point-of-intent, wherein the point-of-intent is identified between the obstacle and the destination point.

15. A platform comprising:
a plurality of vehicles, the plurality of vehicles including a first vehicle, the first vehicle including an autonomy system configured to enable the first vehicle to operate autonomously;
a queue, the queue configured to contain a first supervisory request, the first supervisory request being originated by a first vehicle; and
at least a first teleoperations indirect control arrangement, the first teleoperations indirect control arrangement being arranged to communicate with the plurality of vehicles, the first teleoperations indirect control arrangement configured to obtain the first supervisory request from the queue,
identify a first situation associated with the first supervisory request, wherein the first situation is identified by the first vehicle as affecting operation of the first vehicle,
identify a first mitigation for the first situation,
determine whether the first mitigation includes providing a point-of-intent to the autonomy system,
when it is determined that the first mitigation includes providing the point-of-intent to the autonomy system, providing the point-of-intent to the autonomy system and obtaining, in response to providing the point-of-intent to the autonomy system, a first plurality of potential paths between a current location of the first vehicle and the point-of-intent,
select, using the teleoperations indirect control arrangement, a first potential path of the first plurality of potential paths, and
provide, using the teleoperations indirect control arrangement, a first indication that the first vehicle is to use the first potential path.

16. The platform of claim 15 further including at least a first teleoperations direct control arrangement, the first teleoperations direct control arrangement being arranged to be assigned by the teleoperations indirect control arrangement to take control of the first vehicle when it is determined that the first mitigation does not include providing the point-of-intent to the autonomy system.

17. The platform of claim 15 wherein when it is determined that the first mitigation does not include providing the point-of-intent to the autonomy system, the first teleoperations indirect control arrangement is further arranged to:
determine whether the first mitigation includes providing a blockage indication that identifies a blockage to the autonomy system; and
when it is determined that the first mitigation includes providing the blockage indication that identifies the blockage to the autonomy system, provide the blockage indication that identifies the blockage to the autonomy system and obtain, in response to providing the blockage indication that identifies the blockage to the autonomy system, a second plurality of potential paths that avoids the blockage.

18. The platform of claim 17 wherein the teleoperations indirect control arrangement is further arranged to:
select a second potential path of the second plurality of potential paths; and
providing a second indication that the first vehicle is to use the second potential path.

19. The platform of claim 15 further including a teleoperations direct control arrangement, wherein when it is determined that the first mitigation does not include providing the point-of-intent to the autonomy system, the teleoperations indirect control arrangement is further arranged to:
determine whether the first mitigation includes identifying the teleoperations direct control arrangement to remotely control the first vehicle; and
when it is determined that the first mitigation includes identifying the teleoperations direct control arrangement to remotely control the first vehicle, communicate to the first vehicle and the teleoperations direct control arrangement that the teleoperations direct control arrangement is to take control of the first vehicle.

20. The platform of claim 19 wherein when it is determined that the first mitigation does not include identifying the teleoperations direct control arrangement to remotely control the vehicle, the teleoperations indirect control arrangement communicates to the first vehicle that the first vehicle is to be extracted.
